(19) United States
(12) Patent Application Publication
(10) Pub. No.: US 2010/0271371 A1
(43) Pub. Date: Oct. 28, 2010

(54) DATA PROCESSING DEVICE AND METHOD FOR CONVERTING COORDINATES OF A CURVED SURFACE

(75) Inventors: CHIH-KUANG CHANG, Tu-Cheng (TW); JIN-BO HU, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/575,553

(22) Filed: Oct. 8, 2009

(30) Foreign Application Priority Data
Apr. 27, 2009 (CN) 200910301896.6

(51) Int. Cl. G06T 15/10

(52) U.S. Cl. 345/427

(57) ABSTRACT

A method for converting coordinates of a curved surface is provided. Parameters of the curved surface to be converted are received, and basic data is computed using a B-spline basis function according to the parameters to formulate a data structure. Basic points are determined according to the parameters and the data structure, and coordinates of the curved surface are converted from three-dimensional coordinates to two-dimensional coordinates using the basic points.

### BACKGROUND

1. Technical Field

Embodiments of the present disclosure generally relate to curved surface processing, and more particularly to a data processing device and method for converting three-dimensional coordinates of a curved surface to two-dimensional coordinates.

2. Description of Related Art

In image measuring technology, editing and/or analyzing a curved surface often utilize a data processing device, such as a computer. Curved surfaces are three-dimensional surfaces. It is necessary to convert the recorded coordinates of a three-dimensional curved surface to two-dimensional plane surface coordinates. How to convert coordinates of points of the curved surface from three-dimensional coordinates to two-dimensional coordinates quickly and accurately is a priority.

### BRIEF DESCRIPTION OF THE DRAWINGS

FIG. 1 is a block diagram of one embodiment of a data processing device for converting coordinates of a curved surface;

FIG. 2(A)-2(B) illustrate an example of a three-dimensional model and a UV map corresponding to the three-dimensional model;

FIG. 3 shows a mesh generated by meshing a UV map;

FIG. 4 illustrates an example of a data structure acquired according to basic data;

FIG. 5 is a flowchart of one embodiment of a method for converting coordinates of a curved surface.

FIG. 6 details block S11 of FIG. 5;

FIG. 7 details block S12 of FIG. 5;

FIG. 8 details block S129 of FIG. 7; and

FIG. 9 details block S13 of FIG. 5.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, a word “module,” as used hereinafter, refers to logic embodied in hardware or firmware, or to a collection of software instructions, written in a programming language, such as, for example, Java, C, or assembly. One or more software instructions in the modules may be embedded in firmware. It will be appreciated that modules may comprised connected logic units, such as gates and flip-flops, and may comprise programmable units, such as programmable gate arrays or processors. The modules described hereinafter may be implemented as either software and/or hardware modules and may be stored in any type of computer-readable medium or other computer storage device.

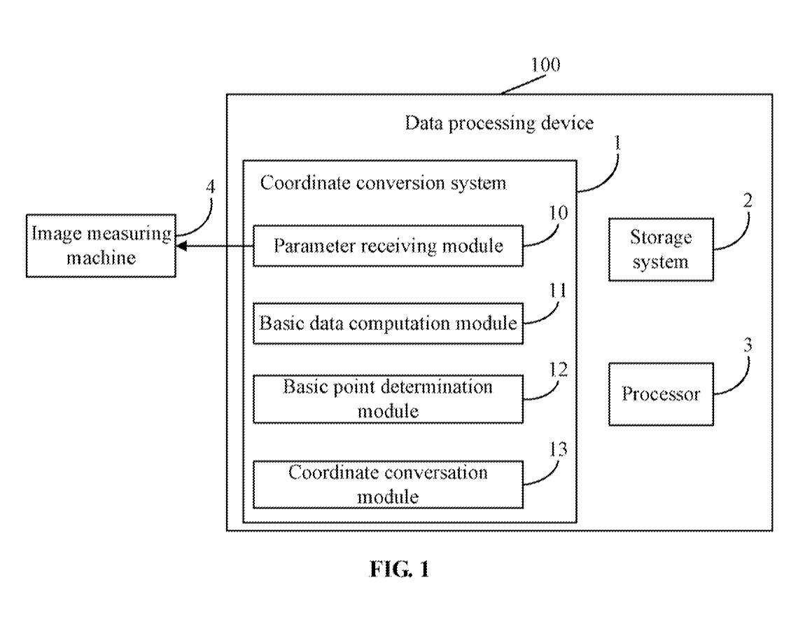

FIG. 1 is a block diagram of one embodiment of a data processing device 100 comprising a coordinate conversion system 1, a storage system 2, and a processor 3. The coordinate conversion system 1 may be used to convert coordinates of a curved surface. The data processing device 100 may be a personal computer, an application server, or a notebook computer, for example. The coordinate conversion system 1 includes a plurality of functional modules (detailed to follow) operable to convert coordinates of points of a curved surface from three-dimensional coordinates to two-dimensional coordinates

In one embodiment, one or more computerized codes of the functional modules of the coordinate conversion system 1 may be stored in the storage system 2. The functional modules include a parameter receiving module 10, a basic data computation module 11, a basic point determination module 12, and a coordinate conversion module 13. The processor 3 is operable to execute the one or more computerized codes of the modules 10-13 to convert coordinates of points of a curved surface from three-dimensional coordinates to two-dimensional coordinates.

The parameter receiving module 10 is operable to receive parameters of a curved surface to be converted. In one embodiment, the parameters may include control points of the curved surface, such as a knot vector, for example. It should be understood that the control points determine the shape of the curved surface. The knot vector is a sequence of parameter values that determines where and how the control points affect the curved surface. An example of a knot vector is (0, 0, 1, 2, 2, 3, 4, 5, 5, 6). In one example, the parameters of the curved surface may be derived from an image measuring machine 4.

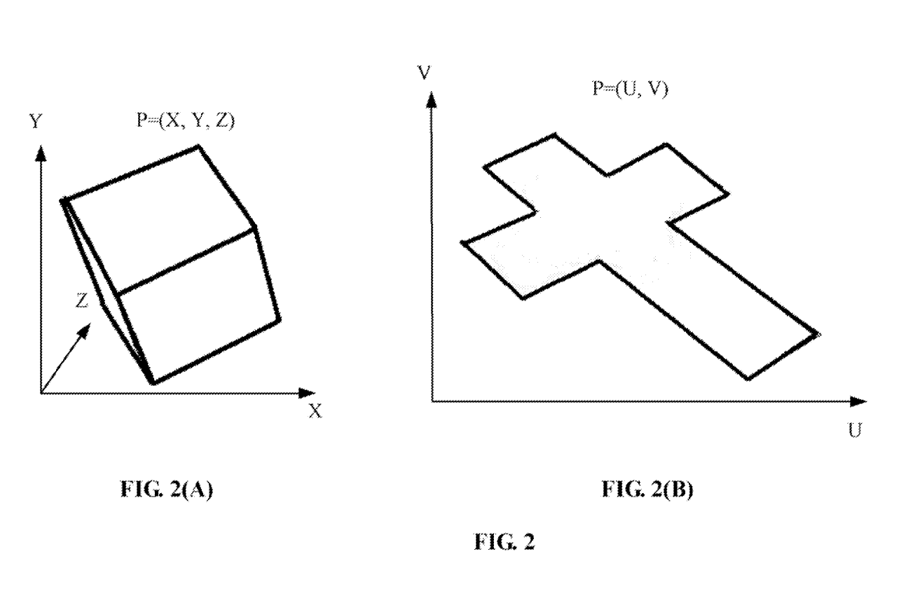

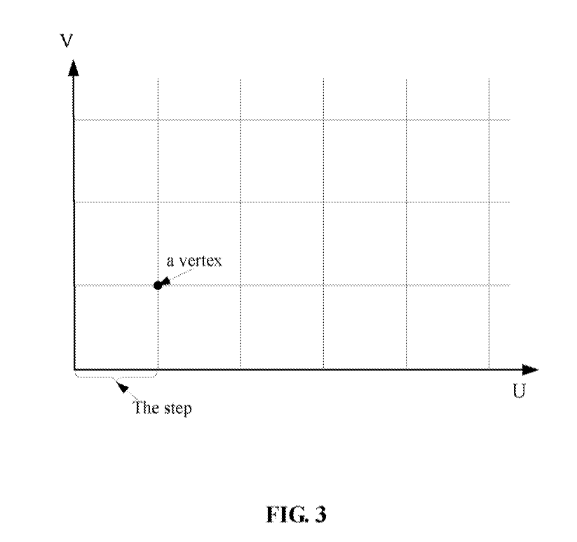

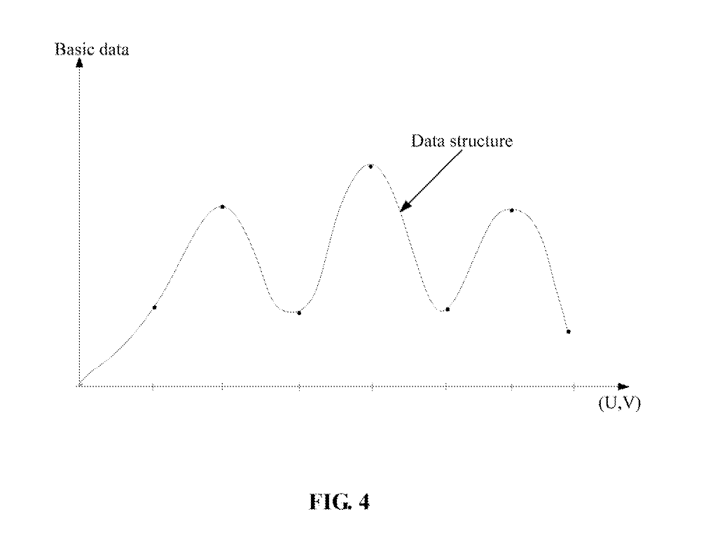

The basic data computation module 11 is operable to compute basic data of the curved surface using a B-spline basis function according to the parameters, and formulate a data structure according to the basic data. In detail, the basic data computation module 11 determines a U value and a V value of a UV map corresponding to the curved surface according to the parameters. It should be understood that the UV map is a two-dimensional image, such as illustrated in FIG. 2(B), that is converted by a three-dimensional model, such as illustrated in FIG. 2(A). In contrast to (X, Y, Z), which are the coordinates for the three-dimensional model in the modeling space, (U, V) are the coordinates of the converted two-dimensional image. In one embodiment, the U value and the V value are determined according to a maximal parameter value and a minimal parameter value of the knot vector. In the example of the knot vector being (0, 0, 1, 2, 2, 3, 4, 5, 5, 6), the U value and the V value are from 0-6. The basic data computation module 11 meshes the UV map by dividing the U value and the V value using a predetermined step to generate a first mesh, and generates first (U, V) coordinates of each vertex in the first mesh. One example of a mesh generated by meshing a UV map is showed in FIG. 3. The basic data computation module 11 computes a plurality of basic data by substitution of each of the first (U, V) coordinates into the B-spline basis function. The basic data computation module 11 formulates a data structure according to the first (U, V) coordinates and the corresponding basic data. An example of the data structure is illustrated in FIG. 4.

The basic point determination module 12 is operable to determine basic points of the curved surface according to the parameters, the UV map, and the data structure. The basic points can be used to convert the coordinates of the curved surface from three-dimensional coordinates to two-dimensional coordinates. In detail, the basic point determination module 12 computes dividing steps of the U value and the V value according the parameters. In one embodiment, the U value or the V value is computed by dividing the U value or the V value by the number of the parameter values of the knot vector. In the example of the knot vector being (0, 0, 1, 2, 2, 3, 4, 5, 5, 6), the number of the parameter values of the knot vector is 10. The U value and the V value are from 0˜6, thus the dividing steps of the U value and the V value are 0.6, which are computed by dividing 6 by 10. The basic point determination module 12 meshes the UV map again by dividing the U value and the V value using the dividing steps to generate a second mesh, and generates second (U, V) coordinates for each vertex in the second mesh. The basic point determination module 12 then computes basic data of each of the second (U, V) coordinates using the data structure. The basic point determination module 12 computes three-dimensional coordinates by substituting the basic data into the NURBS formula for determining the basic points. In addition, if any of angles between normal vectors of each two plane surfaces formed by the basic points exceeds a predetermined value, the basic points determination module 12 supplements the basic points by executing a point insertion operation. In one embodiment, if the angle between normal vectors of a plane surface ABCD and a plane surface CDED exceeds the predetermined value, the point insertion operation includes steps as follows. The basic points determination module 12 obtains the plane surfaces ABCD and CDEF, and converts the plane surfaces ABCD and CDED to a two-dimensional plane surface CDE′F′. The basic points determination module 12 determines a central point of the plane surface CDE′F′, and obtains the two-dimensional coordinates of the central point. The basic points determination module 12 finally converts the two-dimensional coordinates into corresponding three-dimensional coordinates for obtaining a three-dimensional insertion point. The three-dimensional insertion point is one of the supplemented basic points.

The coordinate conversion module 13 is operable to convert coordinates of the curved surface from three-dimensional coordinates to two-dimensional coordinates according to the basic points. In detail, the coordinate conversion module 13 selects a point P in the curved surface. In one embodiment, the selection of the point P can be random. The coordinate conversion module 13 then computes a distance between the point P and each of the plane surfaces formed by the basic points to locate a plane surface which is nearest to the point P. The coordinate conversion module 13 projects the point P onto the nearest plane surface to generate a projected point P′, and obtains a point P″ which corresponds to the point P′ in the UV map. The coordinate conversion module 13 finally obtains the (U, V) coordinates of the point P″. The (U, V) coordinates are the two-dimensional coordinates of the point P of the curved surface. These operations are repeated until coordinates of all points in the curved surface have been converted.

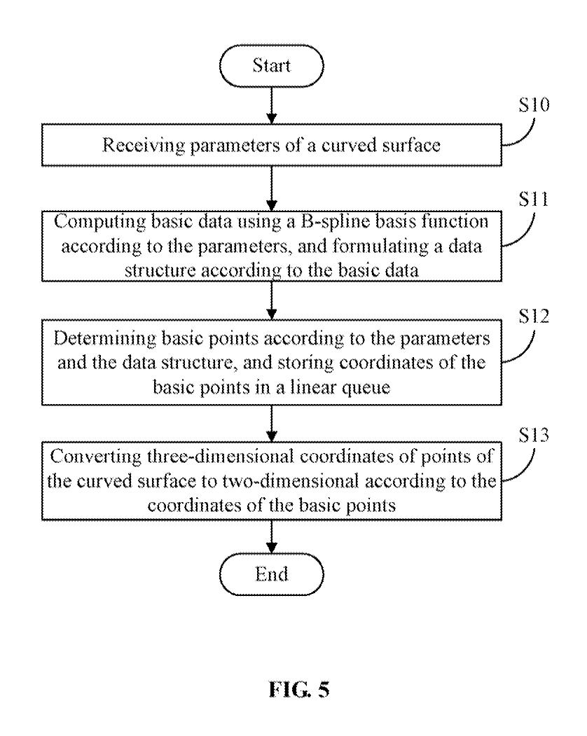

FIG. 5 is a flowchart of one embodiment of a method for converting coordinates of a curved surface. Depending on the embodiment, additional blocks in the flow of FIG. 5 may be added, others removed, and the ordering of the blocks may be changed.

In block S10, the parameter receiving module 10 receives parameters of a curved surface to be converted. In one example, the parameters of the curved surface may be derived from an image measuring machine 4. The parameters may include control points of the curved surface, a knot vector. As mentioned above, The knot vector is a sequence of parameter values. An example of a knot vector is (0, 0, 1, 2, 2, 3, 4, 5, 5, 6).

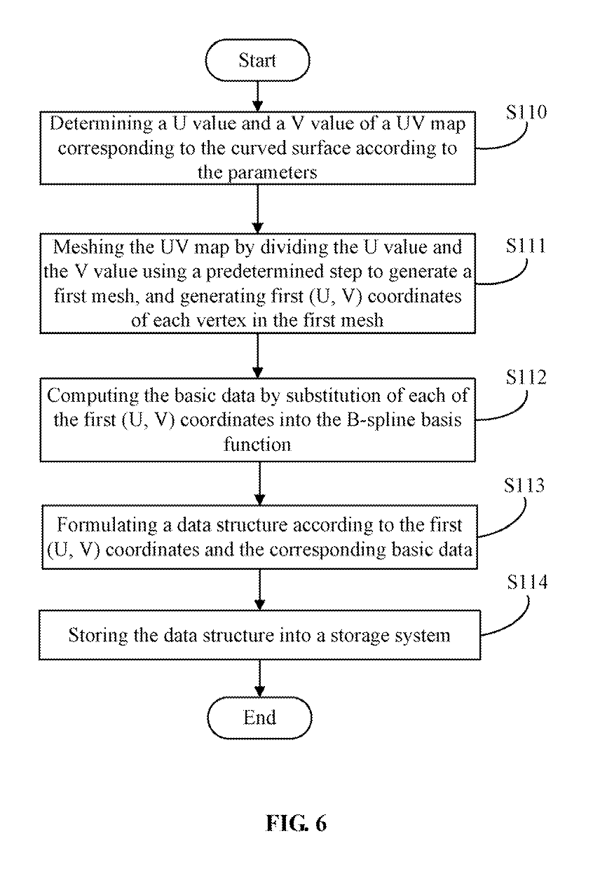

In block S11, the basic data computation module 11 computes basic data of the curved surface using the B-spline basis function according to the parameters, and formulates a data structure according to the basic data. A detailed description of computing the basic data is given as follows, referring to FIG. 6.

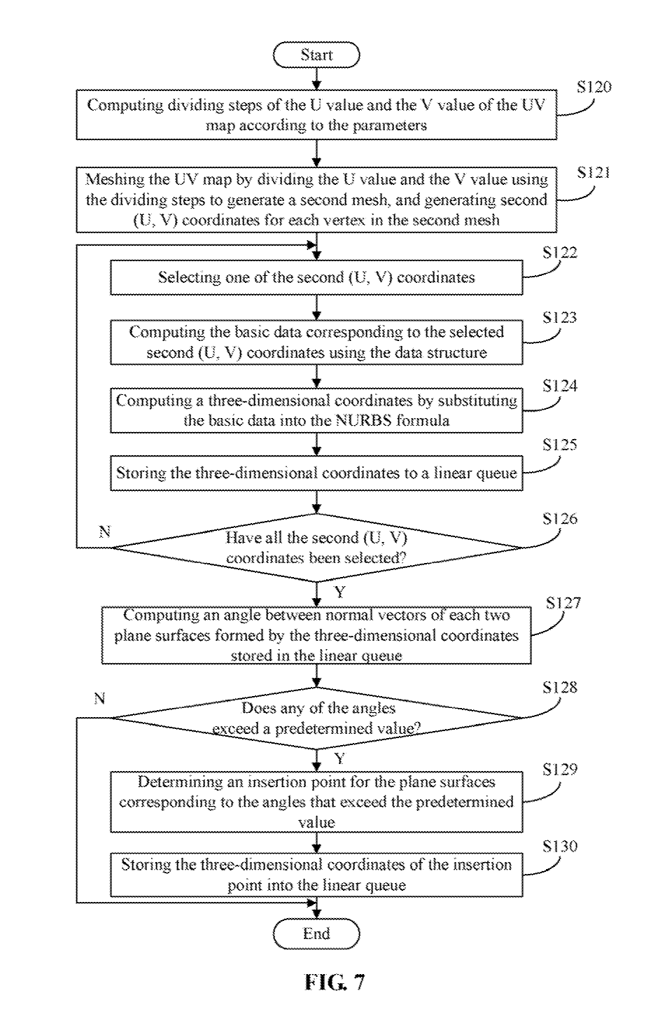

In block S12, the basic points determination module 12 determines basic points of the curved surface according to the parameters, the UV map and the data structure. The basic points can be used to convert the coordinates of the curved surface from three-dimensional coordinates to two-dimensional coordinates. A detailed description of determining the basic points is given as follows, referring to FIG. 7.

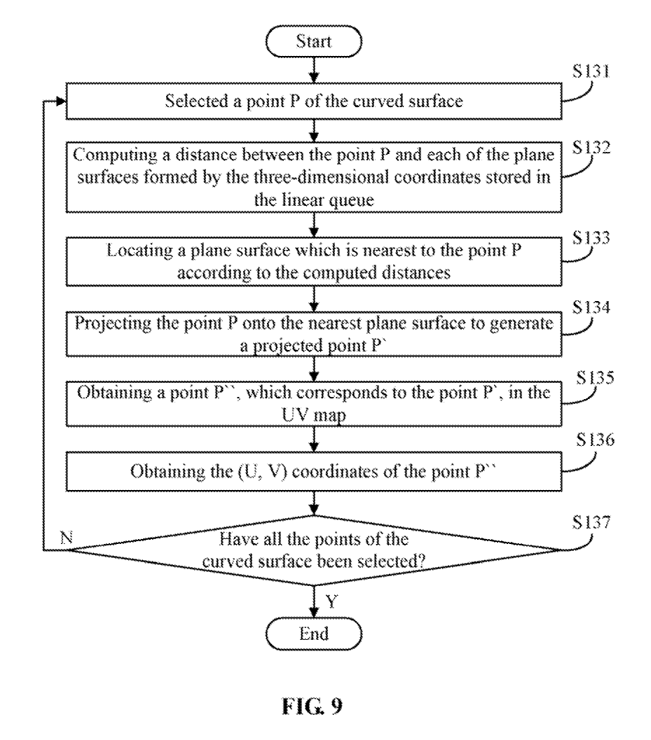

In block S13, the coordinate conversion module 13 converts coordinates of the curved surface from three-dimensional coordinates to two-dimensional coordinates using the basic points. A detailed description of converting the coordinates is given as follows, referring to FIG. 9.

FIG. 6 details block S11 of FIG. 5. Depending on the embodiment, additional blocks in the flow of FIG. 6 may be added, others removed, and the ordering of the blocks may be changed.

In block S110, the basic data computation module 11 determines a U value and a V value of a UV map corresponding to the curved surface according to the parameters. As mentioned, the UV map is a two-dimensional image converted by a three-dimensional model. In contrast to (X, Y, Z), which are the coordinates for the three-dimensional model in the modeling space, (U, V) are the coordinates of the converted two-dimensional image. In one embodiment, the U value and the V value are determined according to a maximal parameter value and a minimal parameter value of the knot vector.

In block S111, the basic data computation module 11 meshes the UV map by dividing the U value and the V value using a predetermined step to generate a first mesh, and generates first (U, V) coordinates of each vertex in the first mesh.

In block S112, the basic data computation module 11 computes a plurality of basic data by substitution of each of the first (U, V) coordinates into the B-spline basis function.

In block S113, the basic data computation module 11 formulates a data structure according to the first (U, V) coordinates and the corresponding basic data.

FIG. 7 details block S12 of FIG. 5. Depending on the embodiment, additional blocks in the flow of FIG. 7 may be added, others removed, and the ordering of the blocks may be changed.

In block S120, the basic points determination module 12 computes dividing steps of the U value and the V value according to the parameters. In one embodiment, the U value or the V value is computed by dividing the U value or the V value by the number of parameter values of the knot vector. In an example of the knot vector being (0, 0, 1, 2, 2, 3, 4, 5, 5, 6), the number of the parameter values of the knot vector is 10. The U value and the V value are from 0˜6, thus, the dividing steps of the U value and the V value is 0.6, which is computed by dividing 6 by 10.

In block S121, the basic points determination module 12 meshes the UV map again by dividing the U value and the V value using the dividing steps to generate a second mesh, and generates second (U, V) coordinates for each vertex in the second mesh.

In block S122, the basic points determination module 12 selects one of the second (U, V) coordinates.

In block S123, the basic points determination module 12 computes the basic data corresponding to the selected second (U, V) coordinates using the data structure.

In block S124, the basic points determination module 12 computes a three-dimensional coordinates by substituting the basic data into the NURBS formula for determining one of the basic points.

In block S125, the basic points determination module 12 stores the three-dimensional coordinates of the basic point into a linear queue of the storage system 2.

In block S126, the basic points determination module 12 determines whether all the second (U, V) coordinates have been selected. If at least one of the second (U, V) has not been selected, block S122 is repeated. Otherwise, if all the second (U, V) coordinates have been selected, block S127 is implemented.

In block S127, the basic points determination module 12 computes an angle between normal vectors of each two plane surfaces formed by the three-dimensional coordinates stored in the linear queue.

In block S128, the basic points determination module 12 determines whether any of the angles exceeds a predetermined value. If not, the process is complete. If so, block S129 is implemented.

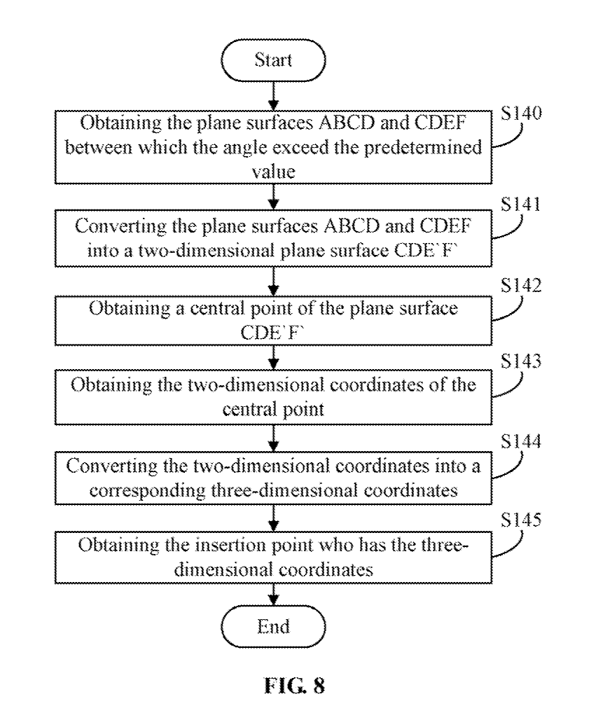

In block S129, the basic points determination module 12 supplements the basic points by determining an insertion point for the plane surfaces corresponding to the angle that exceeds the predetermined value. A detailed description of determination of an insertion point is given as follows, referring to FIG. 8. The insertion point is one of the basic points. It should be understood that determination of an insertion point may repeat if more than one angle exceeds the predetermined value.

In block S130, the basic points determination module 12 stores the three-dimensional coordinate(s) of the insertion point(s) into the linear queue.

FIG. 8 details block S129 of FIG. 7. An angle between a plane surface ABCD and a plane surface CDEF exceeding the predetermined value is used here as an example. Depending on the embodiment, additional blocks in the flow of FIG. 8 may be added, others removed, and the ordering of the blocks may be changed.

In block S140, the basic points determination module 12 obtains the plane surfaces ABCD and CDEF.

In block S141, the basic points determination module 12 converts the plane surfaces ABCD and CDED to a two-dimensional plane surface CDE′F′.

In block S142, the basic points determination module 12 determines a central point of the plane surface CDE′F′.

In block S143, the basic points determination module 12 obtains the two-dimensional coordinates of the central point.

In block S144, the basic points determination module 12 converts the two-dimensional coordinates of the central point to three-dimensional coordinates.

In block S145, the basic points determination module 12 obtains the insertion point having the three-dimensional coordinates.

FIG. 9 details block S13 of FIG. 5. Depending on the embodiment, additional blocks in the flow of FIG. 8 may be added, others removed, and the ordering of the blocks may be changed.

In block S131, the coordinate conversion module 13 selects a point P of the curved surface. In one embodiment, the selection of the point P can be random.

In block S132, the coordinate conversion module 13 computes a distance between the point P and each of the plane surfaces formed by the basic points.

In block S133, the coordinate conversion module 13 finds a plane surface which is nearest to the point P according to the computed distances.

In block S134, the coordinate conversion module 13 projects the point P onto the nearest plane surface to generate a projected point P′.

In block S135, the coordinate conversion module 13 obtains a point P″, which corresponds to the point P′, in the UV map.

In block S136, the coordinate conversion module 13 obtains the (U, V) coordinates of the point P″. It should be understood that the (U, V) coordinates are the two-dimensional coordinates of the point P of the curved surface.

In block S137, the coordinate conversion module 13 determines whether all the points of the curved surface have been selected. If at least one of the points of the curved surface has not been selected, block S131 is repeated. Otherwise, if all the points of the curved surface have been selected, the process is complete.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A method for converting coordinates of a curved surface, the method performed by execution of computer readable program code by at least one processor of at least one computer system, the method comprising:
(a) receiving parameters of the curved surface to be converted;
(b) computing basic data of the curved surface using a B-spline basis function according to the parameters, and formulating a data structure according to the basic data;
(c) determining basic points of the curved surface according to the parameters and the data structure; and
(d) converting coordinates of the curved surface from three-dimensional coordinates to two-dimensional coordinates using the basic points.

2. The method as described in claim 1, wherein the parameters comprise control points of the curved surface and a knot vector that comprises a sequence of parameter values.

3. The method as described in claim 1, wherein block (b) comprises:
determining a U value and a V value of a UV map corresponding to the curved surface according to the parameters;
meshing the UV map by dividing the U value and the V value using a predetermined step to generate a first mesh, and generating first (U, V) coordinates of each vertex in the first mesh;
computing a plurality of basic data by substitution of each of the first (U, V) coordinates into the B-spline basis function; and
formulating a data structure according to the first (U, V) coordinates and the corresponding basic data.

4. The method as described in claim 1, wherein block (c) comprises:
(c1) computing dividing steps of the U value and the V value according to the parameters;
(c2) meshing the UV map by dividing the U value and the V value using the dividing steps to generate a second mesh, and generating second (U, V) coordinates for each vertex in the second mesh;
(c3) selecting one of the second (U, V) coordinates;
(c4) computing the basic data corresponding to the selected second (U, V) coordinates using the data structure;
(c5) computing a three-dimensional coordinates by substituting the basic data into the NURBS formula for determining one of the basic points;
(c6) storing the three-dimensional coordinates of the basic point into a linear queue of a storage system; and
repeating blocks from (c3) to (c6) until all the second (U, V) coordinates have been selected.

5. The method as described in claim 4, wherein block (c) further comprises:
(c7) computing an angle between normal vectors of each two three-dimensional plane surfaces formed by the three-dimensional coordinates stored in the linear queue;
(c8) determining whether any of the angles exceeds a predetermined value; and
(c9) determining an insertion point for the three-dimensional plane surfaces corresponding to the angle, which exceeds the predetermined value, for supplementing the basic points.

6. The method as described in claim 5, wherein block (c9) comprises:
(c90) obtaining the three-dimensional plane surfaces between which the angle exceeds the predetermined value;
(c91) converting the three-dimensional plane surfaces into a two-dimensional plane surface;
(c92) determining a central point of the two-dimensional plane surface, and obtaining the two-dimensional coordinates of the central point;
(c93) converting the two-dimensional coordinates of the central point into a three-dimensional coordinate; and
(c94) obtaining the insertion point having the three-dimensional coordinate.

7. The method as described in claim 1, wherein block (d) comprises:
(d1) selecting a point P of the curved surface;
(d2) computing a distance between the point P and each of the plane surfaces formed by the basic points;
(d3) finding a plane surface which is nearest to the point P according to the computed distances;
(d4) projecting the point P onto the nearest plane surface to generate a projected point P′;
(d5) obtaining a point P″, which corresponds to the point P′, in a UV map corresponding to the curved surface;
(d6) obtaining the (U, V) coordinates of the point P″, wherein the (U, V) coordinates are the two-dimensional coordinates of the point P of the curved surface; and
repeating blocks (d1) to (d6) until all the points of the curved surface have been selected.

8. A storage medium having stored thereon instructions that when executed by a processor cause the processor to perform a method for converting coordinates of a curved surface, wherein the method comprises:
(a) receiving parameters of the curved surface to be converted;
(b) computing basic data of the curved surface using a B-spline basis function according to the parameters, and inducing a data structure according to the basic data;
(c) determining basic points of the curved surface according to the parameters and the data structure; and
(d) converting coordinates of the curved surface from three-dimensional coordinates to two-dimensional coordinates using the basic points.

9. The storage medium as described in claim 8, wherein the parameters include control points of the curved surface and a knot vector comprising a sequence of parameter values.

10. The storage medium as described in claim 8, wherein block (b) comprises:
determining a U value and a V value of a UV map corresponding to the curved surface according to the parameters;
meshing the UV map by dividing the U value and the V value using a predetermined step to generate a first mesh, and generating first (U, V) coordinates of each vertex in the first mesh;
computing a plurality of basic data by substitution of each of the first (U, V) coordinates into the B-spline basis function; and
inducing a data structure according to the first (U, V) coordinates and the corresponding basic data.

11. The storage medium as described in claim 8, wherein block (c) comprises:
(c1) computing dividing steps of the U value and the V value according to the parameters;
(c2) meshing the UV map by dividing the U value and the V value using the dividing steps to generate a second mesh, and generating second (U, V) coordinates for each vertex in the second mesh;
(c3) selecting one of the second (U, V) coordinates;
(c4) computing the basic data corresponding to the selected second (U, V) coordinates using the data structure;
(c5) computing a three-dimensional coordinates by substituting the basic data into the NURBS formula for determining one of the basic points;
(c6) storing the three-dimensional coordinates of the basic point into a linear queue of a storage system; and
repeating blocks (c3) to (c6) until all the second (U, V) coordinates have been selected.

12. The storage medium as described in claim 8, wherein block (c) further comprises:
(c7) computing an angle between normal vectors of each two three-dimensional plane surfaces formed by the three-dimensional coordinates stored in the linear queue;
(c8) determining whether any of the angles exceeds a predetermined value; and
(c9) determining an insertion point for the three-dimensional plane surfaces corresponding to the angle that exceeds the predetermined value for supplementing the basic points.

13. The storage medium as described in claim 8, wherein block (c9) comprises:
(c90) obtaining the three-dimensional plane surfaces between which the angle exceeds the predetermined value;
(c91) converting the three-dimensional plane surfaces into a two-dimensional plane surface;
(c92) determining a central point of the two-dimensional plane surface, and obtaining the two-dimensional coordinates of the central point;
(c93) converting the two-dimensional coordinates of the central point to a three-dimensional coordinate; and
(c94) obtaining the insertion point having the three-dimensional coordinate.

14. The storage medium as described in claim 8, wherein block (d) comprises:
(d1) selecting a point P of the curved surface;
(d2) computing a distance between the point P and each of the plane surfaces formed by the basic points;
(d3) finding a plane surface which is nearest to the point P according to the computed distances;
(d4) projecting the point P onto the nearest plane surface to generate a projected point P′;
(d5) obtaining a point P″, which corresponds to the point P′, in a UV map corresponding to the curved surface;
(d6) obtaining the (U, V) coordinates of the point P″, wherein the (U, V) coordinates are the two-dimensional coordinates of the point P of the curved surface; and
repeating blocks (d1) to (d6) until all the points of the curved surface have been selected.

15. A data processing device for converting coordinates of a curved surface, the data processing device comprising:
a parameter receiving module operable to receive parameters of the curved surface to be converted;
a basic data computation module operable to compute basic data of the curved surface using a B-spline basis function according to the parameters, and formulate a data structure according to the basic data;
a basic point determination module operable to determine basic points of the curved surface according to the parameters and the data structure;
a coordinate conversion module operable to convert coordinates of the curved surface from three-dimensional coordinates to two-dimensional coordinates according to the basic points; and
a processor that executes the parameter receiving module, the basic data computation module, the basic point determination module, and the coordinate conversion module.

16. The data processing device as described in claim 15, wherein the parameters comprise control points of the curved surface, and a knot vector.

17. The data processing device as described in claim 15, wherein the basic data computation module computes the basic data by:
determining a U value and a V value of a UV map corresponding to the curved surface according to the parameters, meshing the UV map by dividing the U value and the V value using a predetermined step to generate a mesh, generating (U, V) coordinates of each vertex in the mesh, and computing a plurality of basic data by substitution of each of the (U, V) coordinates into the B-spline basis function.

18. The data processing device as described in claim 15, wherein the basic point determination module determines the basic points by:
computing dividing steps of the U value and the V value according to the parameters, meshing the UV map by dividing the U value and the V value using the dividing steps to generate a mesh, generating (U, V) coordinates for each vertex in the mesh, computing basic data of each of the (U, V) coordinates using the data structure, computing three-dimensional coordinates by substituting the basic data into the NURBS formula for determining the basic points, and storing the three-dimensional coordinates of the basic points into a linear queue.

19. The data processing device as described in claim 18, wherein the basic point determination module further determines the basic points by:
computing an angle between normal vectors of each two the three-dimensional plane surfaces formed by the three-dimensional coordinates stored in the linear queue, obtaining the three-dimensional plane surfaces between which the angle exceeds a predetermined value, converting the obtained three-dimensional plane surfaces into a two-dimensional plane surface, determining a central point of the two-dimensional plane surface, obtaining the two-dimensional coordinates of the central point, converting the two-dimensional coordinates of the central point into three-dimensional coordinate, and obtaining the insertion point having the three-dimensional coordinates for supplementing the basic points.

20. The data processing device as described in claim 15, wherein the coordinate conversion module converts the coordinates by:
selecting a point P of the curved surface, computing a distance between the point P and each of the plane surfaces formed by the basic points to find a plane surface which is nearest to the point P according to the computed distances, projecting the point P onto the nearest plane surface to generate a projected point P′, obtaining a point P″, which corresponds to the point P′, in a UV map corresponding to the curved surface, and obtaining the (U, V) coordinates of the point P″, wherein the (U, V) coordinates are the two-dimensional coordinates of the point P of the curved surface.
